(19) United States
(12) Patent Application Publication
(10) Pub. No.: US 2008/0253071 A1
(43) Pub. Date: Oct. 16, 2008

(54) Support arm for a flatscreen

(75) Inventors: Dirk Jan Stoelinga, Baarn (NL); Franciscus Wilhelmus Johannes Bende, Soest (NL)

Correspondence Address: YOUNG & THOMPSON, 209 Madison Street, Suite 500, ALEXANDRIA, VA, 22314, US

(73) Assignee: S&B SYSTEMS B.V., SOEST (NL)

(21) Appl. No.: 11/783,474

(22) Filed: Apr. 10, 2007

(51) Int. Cl. F16M 13/02

(52) U.S. Cl. 361/681; 16/237

(57) ABSTRACT

A support arm for a flat screen like an LCD display, for mounting the flat screen to a surface, like a wall, includes a first fastening part for attaching the support arm to the surface, a first member, at on end hingedly connected to the first fastening part, a second member, at one end hingedly connected to the other end of the first member, a second fastening part for attaching the flat screen to the support arm, and which is hingedly connected to the other end of the second member, and which first member has a space for holding the second member when the arm is in a folded position.

### BACKGROUND

The present invention relates to a support arm for a flat screen, like an LCD display, for mounting the flat screen to a flat surface, like a wall.

Such a support arm is known from EP-A2-1.312.852 and GB-2.416.062, for instance. These arms have a first member which is pivotally connected to a second member. The arms are not specifically suited for mounting a flat screen to for instance a wall. Due to their construction, these arms leave a substantial distance between a flat screen and a wall when the arm is in its folded position.

Another arm is disclosed in U.S. Pat. No. 5,321,579. In its folded position, this arm is very flat, holding a flat screen almost against a wall. This arm, however, needs to be mounted underneath a flat screen of flat panel display.

### SUMMARY OF THE INVENTION

The invention aims at providing a support arm an alternative support arm, which folds in a flat way between the back of a flat screen and a wall or another flat surface.

Another object of the invention is to provide a support arm which is easy and cheap to produce.

According to a first aspect of the invention this is realized with a support arm for a flat screen, like an LCD display, for mounting the flat screen to a surface, like a wall, comprising a first fastening part for attaching the support am to the surface, a first member, at on end hingedly connected to said first fastening part, a second member, at one end hingedly connected to the other end of the first member, a second fastening part for attaching the flat screen to the support arm, and which is hingedly connected to the other end of the second member, and one of said members has a space for holding said other member when said arm is in a folded position.

This support arm can be folded behind a flatscreen in a very flat manner. In stays almost unnoticed.

In an embodiment, the second member has said space for holding said first member when said arm is in a folded position.

In an embodiment of the invention, the first member comprises a substantially U-shaped profile part.

In an embodiment of the invention, the second member comprises a substantially U-shaped profile part.

In this way, a very simple and uncomplicated construction is possible.

In an embodiment, the first member is shorter than said second member.

In an embodiment, the first member is smaller in height than said second member. This allows the first member to be fully incorporated in the second member when the arm is in its folded position.

In an embodiment, the second member comprises a substantially U-shaped profile part having a space between the two legs which is suited for holding the first member in the folded position of the arm.

In an embodiment, the space of said member is adapted for holding at least part of said first fastening part.

In an embodiment, the second fastening part is hingedly connected to the other end of the second member, said second fastening part comprising:

an attachment part having a first side for attaching to a flatscreen, and a second side provided with

a first, horizontal axle, substantially parallel to a plane of movement of said arm, rotatably mounted to said attachment part,

a second, vertical axle, substantially parallel to the rotational axes of the hinges of said arm, fixed to the horizontal axle and rotatably mounted at the other end of the second member for providing a hinged connection of said second fastening part to said second member.

This fastening part is very simple, yet robust. Furthermore, it allows both tilting and swiveling.

The invention further relates to a support arm for a flat screen, like an LCD display, for mounting the flat screen to a surface, like a wall, comprising:

a first fastening part for attaching the support arm to said surface,

a first member, at one end hingedly connected to said first fastening part,

a second member, at one end hingedly connected to the other end of the first member,

a second fastening part for attaching the flat screen to the support arm, and which is hingedly connected to the other end of the second member, said second fastening part comprising:

an attachment part having a first side for providing an attachment to a flatscreen, and a second side provided with

a first, horizontal rod, substantially perpendicular to said hinges and rotatably mounted to said attachment part,

a second, vertical rod, fixed to the horizontal axle, tiltably mounted to the attachment part and rotatably mounted at the other end of the second member for providing a hinged connection of said second fastening part to said second member.

In an embodiment of this support arm, the attachment part has slots, and said attachment part further comprises an attachment plate for attaching to a flatscreen and having hooks for engaging in said slots.

The invention further relates to a fastening part for connecting a flat screen to an end of an arm for allowing said flatscreen to tilt and swivel with respect to said end of said arm, said fastening part comprising:

an attachment part having a first side for attaching to a flatscreen, and a second side provided with

a first, horizontal axle or pin, rotatably mounted to said attachment part,

a second, vertical axle or pin, fixed to the horizontal axle and rotatably mountable to the end of the arm for providing a hinge connection of said second fastening part to said second member.

This fastening part can be produces in large quantities, fast, and economically. Furthermore, it allows the attachment of a large variety of different flatscreens.

In an embodiment, the fastening part has a blocking which engages said second axle for holding said attachment part in a tilt position.

In an embodiment, the blocking comprises at least one slotted lip, and an end of said second axle extends through said slot.

This allows the flatscreen to be positioned in an almost free manner.

The various aspects discussed in tis patent can be combined in order to provide additional advantageous advantages.

### DESCRIPTION OF THE DRAWINGS

The invention will be further elucidated referring to an preferred embodiment shown in the drawing wherein shown in:

FIG. 1 an arm in a partially unfolded position, seen from the back;

FIG. 2 the arm of FIG. 1 in the partially unfolded position of FIG. 1, in rear view;

FIG. 3 the arm of FIG. 1 in the partially unfolded position of FIG. 1, in top view;

FIG. 4 the arm of FIG. 1 in folded position, in front view;

FIG. 5 the arm of FIG. 1 in the folded position of FIG. 6, in top view;

FIG. 6 the arm of FIG. 1 in the folded position of FIG. 6, in front view, with the flat screen fastening part in downward-tilted position;

FIG. 7 the am of FIG. 1 in unfolded position in front view and with the fastening part rotated in one direction and in downward-tilted position;

FIG. 8 the arm in the position of FIG. 9, in top view;

FIG. 9 a coupling plate for coupling a flatscreen to a fastening part, in perspective view;

FIGS. 10A and 10B an alternative fastening part in rear view and in side view;

FIG. 11 yet another alternative fastening, and

FIG. 12 application of the alternative fastening in rear view.

### DETAILED DESCRIPTION OF THE EMBODIMENTS

In the figures an embodiment of a support arm according to the invention is shown.

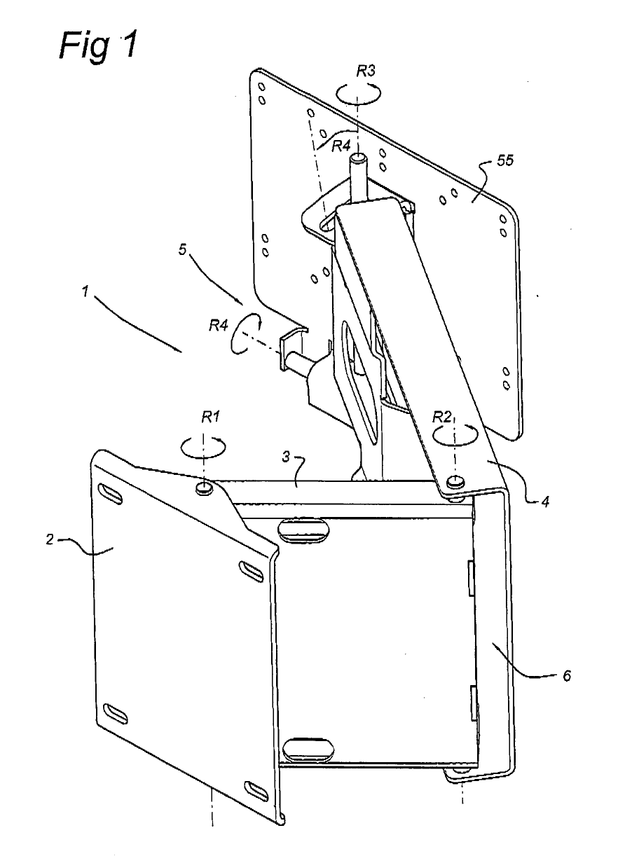

FIG. 1 is a rear perspective view of a support arm 1 in partially unfolded position. The arm 1 has a first fastening part 5 for attaching or mounting the arm 1 to a wall or another flat surface. Hingedly attached to the first fastening part 5 is a first member 4. This first member 3 can thus rotate about rotational axis R1.

Arm 1 further has a second member 4 which at one end is hingedly connected to the end of the first member 3. Thus, the second member 4 can rotate or binge about rotational axis R2. At the other end of second member 4, the arm 1 has a second fastening part 5 to which a flat screen an be attached. The second fastening member is rotatably coupled at the other end of second member 4 to be able to rotate about rotational axis R3. Furthermore, second fastening part 5 is rotatable about rotational axis R4. In that way, an attached flat screen can tilt downwardly.

Second member 4 has a space 6 for taking up the first member 3 when the arm 1 is in its folded position, as shown below. This space 6 in this embodiment can also take up part of the first fastening part 2.

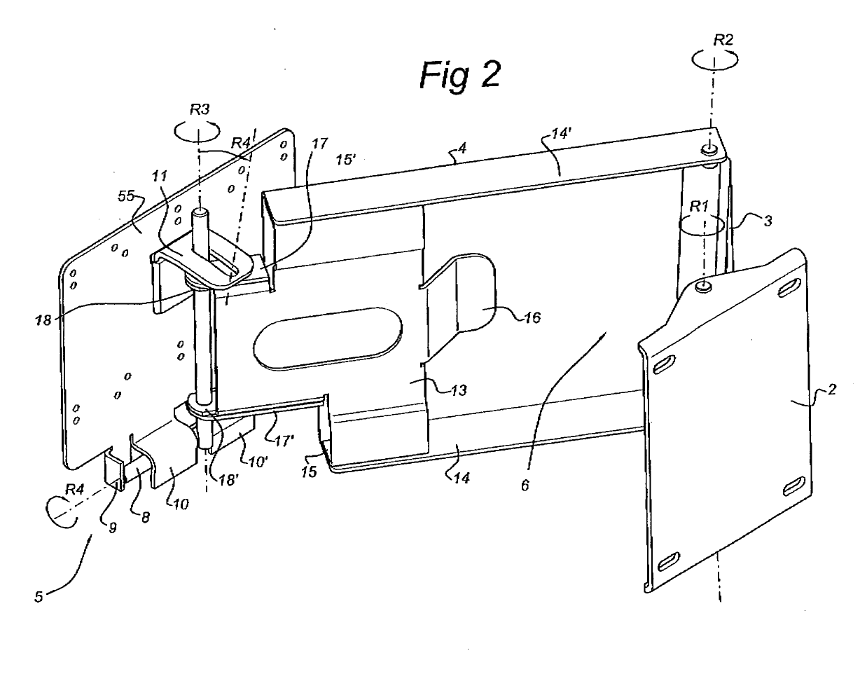

FIG. 2 shows the arm 1 of FIG. 1 in the position of FIG. 1, but now seen from an other angle. From this angle, the back side of the second fastening part 5 to which a flatscreen can be attached can be seen. In order to tilt the flatscreen, the second fastening part 5 is rotatable about rotational axis R4. To that end, the second fastening part 5 as a bar 8 which is rotatably held between lips 9, 9′ (which can not be seen in this drawing) in its longitudinal direction and by lips 10 and 10′ in its transverse direction. In this embodiment, these lips are turned or bent parts of plate 5 which is part of the second fastening part 5. In order to fix the second fastening part in a tilted position, horizontal bar 8 has a second, vertical bar 7 attached to it. This vertical bar 7 extends through a lip 11 which is attached to plate 5. Lip 11 is slightly curved downward and has a slot in which the vertical bar can move back and forth in order to make the rotational movement about rotational axis R4 possible. In an embodiment, the vertical bar 7 has a threaded end extending through the lip 11 and a nut. By turning the nut, plate 5 can be fixed in a tilted position.

In his embodiment, the vertical bar 7 is rotatably held by lips 18, 18′ and 17, 17′ at the end of second member 4. In that way, the plate 5 can rotate about rotational axis R3. In this way, a simple, cheap and easy to produce construction is made which provides a rotational degree of freedom and a tilting degree of freedom to a flatscreen attached to the arm 1.

From this angle, it is also visible that the second member 4 is essentially a plate with its two sides 14 and 14′ bent at 90 degrees. In his way, the space 6 for taking up the first member and large part of the first fastening part 2 is easily realised.

Furthermore, this provides a simple and cheap way to provide the second member 4. In order to add to the rigidness and to provide torsion stiffness, to the second member, it has a plate 13 with bent sides 15, 15′ attached to the bent sides 14, 14′, and a lip 16 attached. At the other end of plate 13, parts are bent to provide lips 17, 17′ which are again welded, to lips 18, 18′ which are bent parts of the plate from which the second member 4 is mainly produced. In that way, a box-like construction is provided which provides stiffness to the second member 4 and to the lips which hold vertical bar 7.

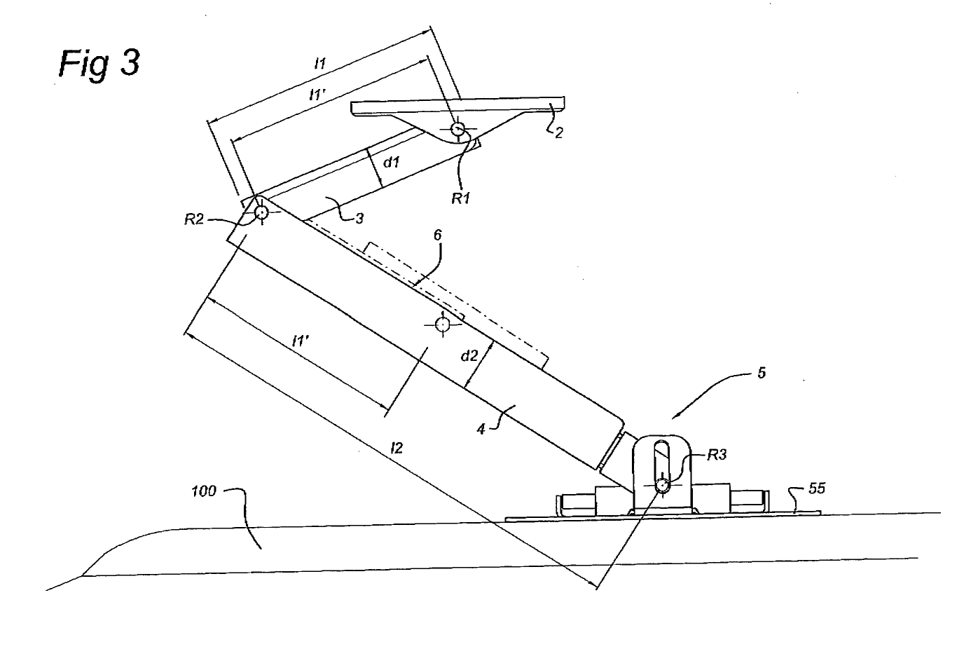

In FIG. 3, a top view of arm 1 is depicted. Attached to plate 55 of second fastening part 5, schematically a flatscreen 100 is shown.

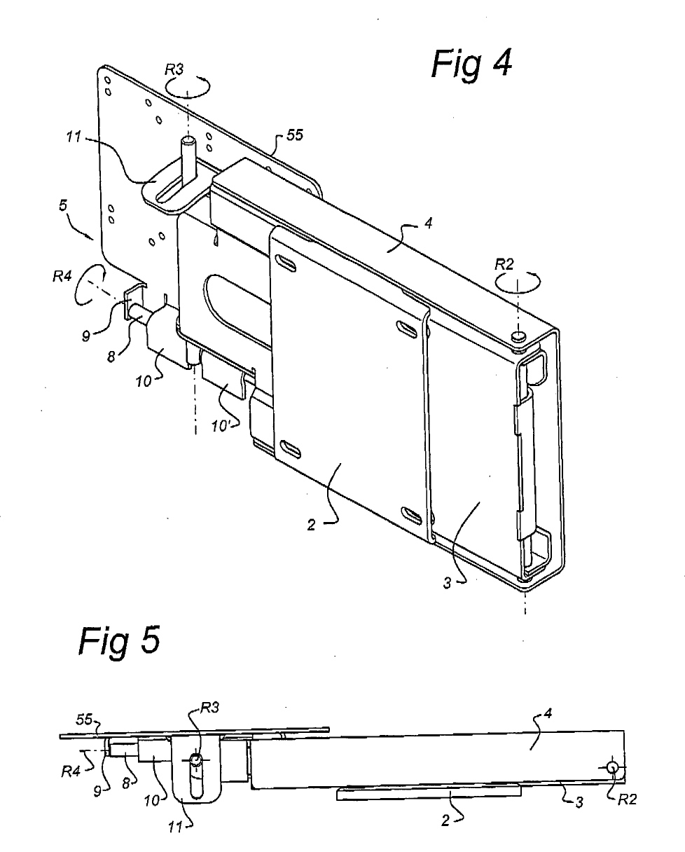

In this top view, the dependency of the different elements of the arm 1 is shown. In order to be able to take up first member 3 in the space 6 of second element 4, length 11 of the first member 3 should be smaller than the length of the second member 4. Furthermore, the width d1 of the first member 3 should he smaller than width d2 of second member 4. In dotted lines, the position in this embodiment of the first member 3 and first fastening part 2 in the folded position of the arm 1 is indicated for clarity. In FIGS. 4 and 5, the arm 1 in folded situation and with the second fastening part in non-tilted position is shown, both in perspective, rear view and in top view. The arm 1 in folded situation is very compact and will hardly be visible between for instance a wall and the flatscreen.

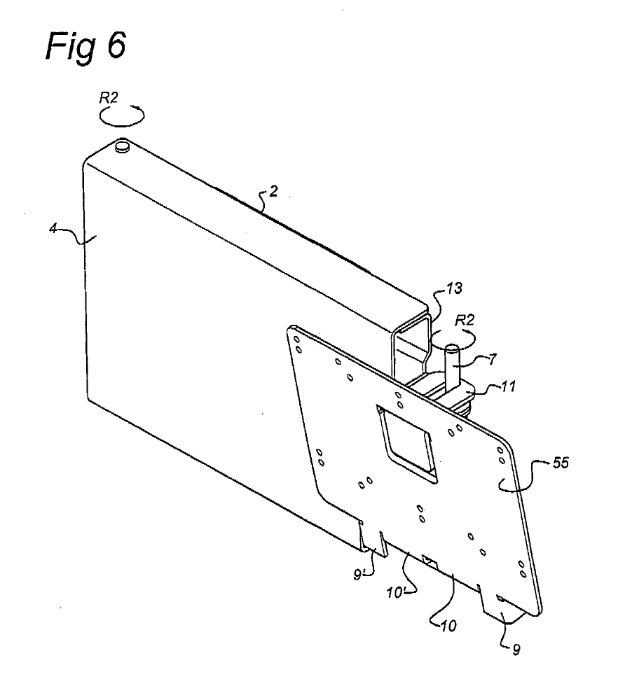

In FIG. 6, the second fastening part, to which in use the flatscreen will be mounted, is shown in maximum tilted position. The vertical bar 7 is in its end position in the slot of lip 11. The end of vertical bar 7 may be provided with for instance thread and a (hand-operable) nut may be its end in order to fix vertical bar 7 in a position in the slot of lip 11.

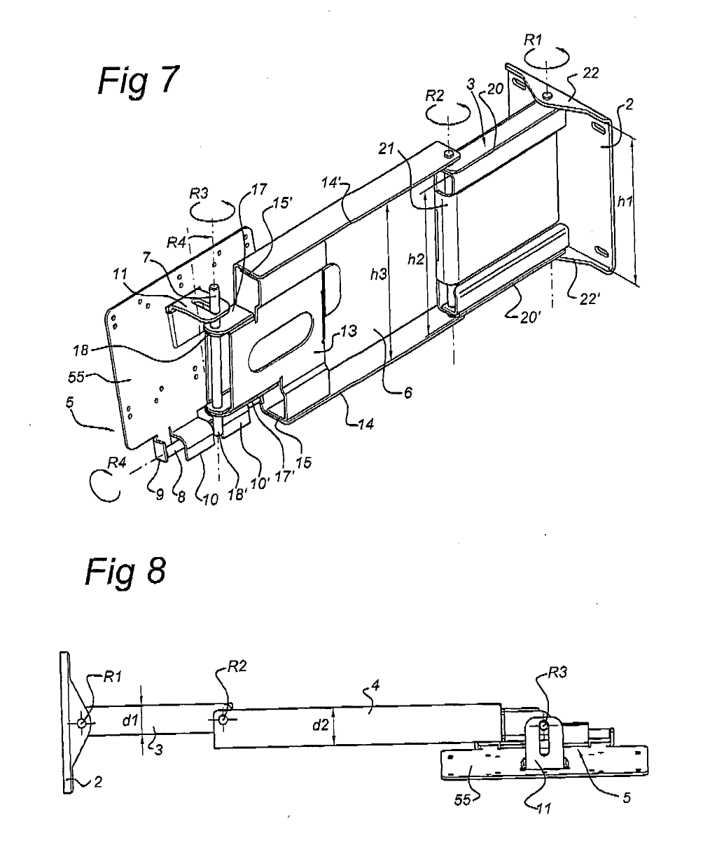

In FIGS. 7 and 8, arm 1 is shown in its maximum extended of unfolded situation or position, and second fastening part 5 is in its maximum tilted position. In FIG. 7, the height of the space 6 in second member 4 is indicated. This height should be more than the height (outside measure) of first member 3 in order to make it possible to take up the first member 3 and past of the first fastening part 2 in space 6.

The first fastening part 2 is here a plate with holes which make it possible to mount the arm by means of for instance screws to for instance a wall. The plate has lips 22 which are folded for providing a means for mounting a shaft for providing rotational axis R1.

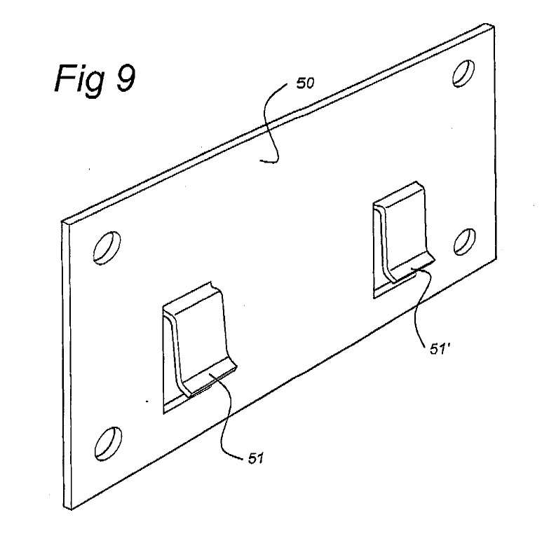

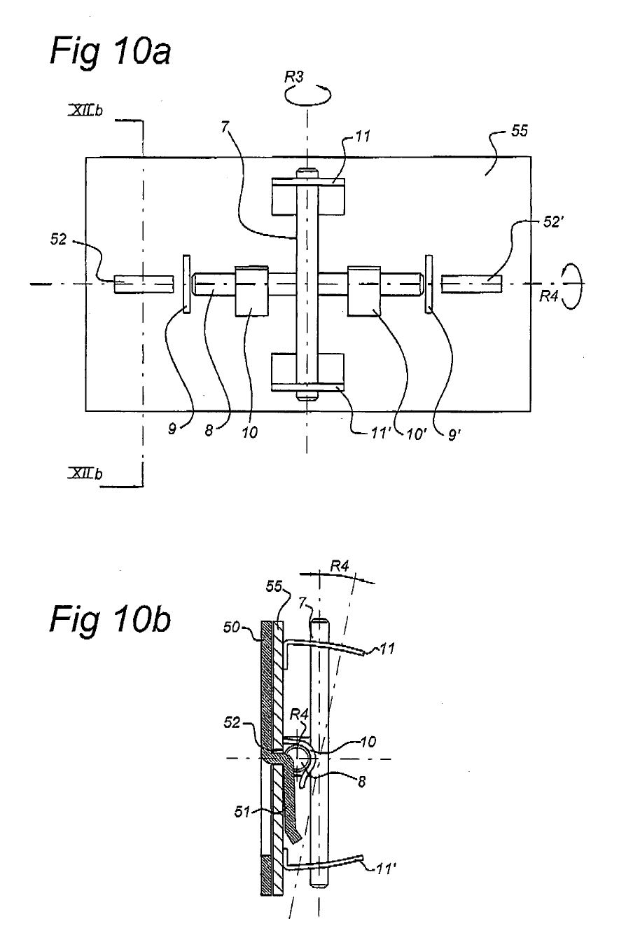

FIG. 9 shows a plate 50 provided with hooks 51 which are bent parts of the plate 50. This plate can be mounted on the back side of a flatscreen. The hooks 51 can be placed through slots 52 in plate 55 of the second fastening part 5 of FIG. 10a. The plate can be mounted in two ways (as indicated in FIG. 10b, and upside down. In that way, arm 1 can be attached to the back of a flatscreen in two way: directing to the left and to the right.

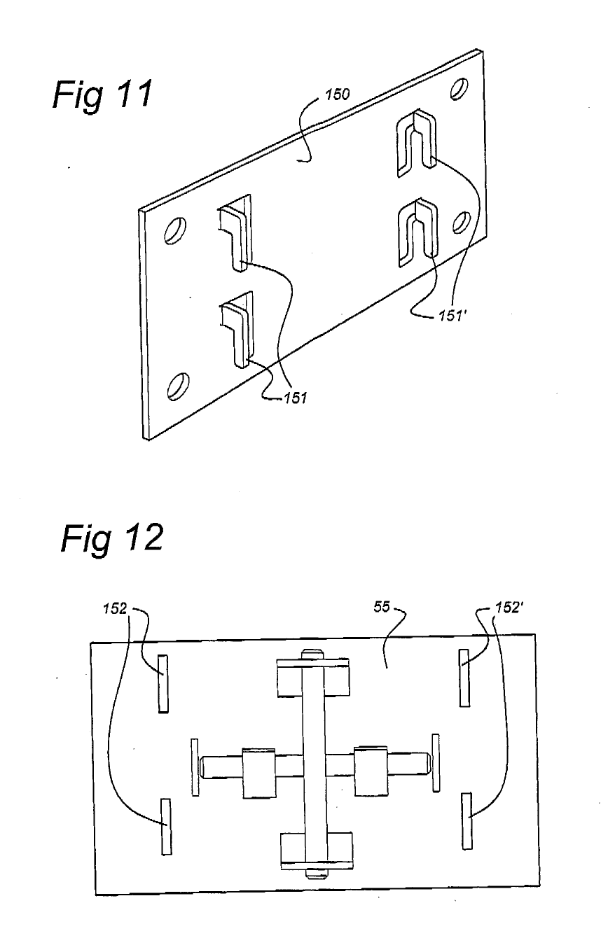

FIG. 11 shows another embodiment of the plate, with reference number 150 and books 151. FIG. 12 shown an embodiment of the second fastening part 5 for such a plate 150. In that way, arm 1 can be attached to the back of a flatscreen in two way: directing to the left and to the right.

In FIGS. 10a and 10b, another embodiment of the second fastening part 5 is shown. This embodiment makes it possible to tilt a flatscreen in two directions, both upward and downward i.e. the direction indicated with R4, and in the other way, around rotational axis R4, made possible by the rotatable mounting of bar 8. The vertical bar or pin 7, here welded to horizontal bar or pin 8, at the same time provides an axis of rotation R3, and a means for fixing the fastening part 5 in a set tilted position. To that end, for instance the upper end of bar 7 can be provided with a threaded end and a nut (not shown).

The vertical bar 7 is fixed to the horizontal bar 8 remote from the plate 55. Slotted lips 11 are here welded against the back of plate 55, but can also be parts of plate 55 of which the contour is punched out and which are subsequently bent out of the plane of plate 55. For that matter, also lips 9, 9′ and hooks 10, 10′ can be made in that way. Vertical bar 7 reaches through the slots of lips 11, 11′, which thus provide a blocking for plate 55 in a tilted position with respect to the longitudinal direction of bar 7. By means of for instance a cam at the lower end of bar 7, past lip 11′, and a threaded end with a nut at the upper end of bar 7, past lip 11, the tilted position can be fixed.

Thus, plate 55 is tiltable about rotational axis R4 (tilt angle in one direction indicated), and can swivel about rotational axis R3.

It will be obvious after the above description and drawings are included to illustrate some embodiments of the invention, and not to limit the scope of protection. Starting from this disclosure, many more embodiments will be evident to a skilled person which are within the scope of protection and the essence of this invention and which are obvious combinations of prior art techniques and the disclosure of this patent.

I claim:

1. A support arm for a flat screen, like an LCD display, for mounting the flat screen to a surface, like a wall, comprising a first fastening part for attaching the support arm to the surface, a first member, at on end hingedly connected to said first fastening part, a second member, at one end hingedly connected to the other end of the first member, a second fastening part for attaching the flat screen to the support arm, and which is hingedly connected to the other end of the second member, and one of said members has a space for holding said other member when said arm is in a folded position.

2. The support arm of claim 1, wherein said second member has said space for holding said first member.

3. The support arm according to claim 1, wherein said first member comprises a substantially U-shaped profile part.

4. The support arm according to claim 3, wherein said second member comprises a substantially U-shaped profile part.

5. The support arm according to claim 1, wherein said first member is shorter than said second member.

6. The support arm according to claim 1, wherein said first member is smaller in height than said second member.

7. The support arm according to claim 1, wherein said second member comprises a substantially U-shaped profile part having a space between the two legs which is suited for holding the first member in the folded position of the arm.

8. The support arm of claim 1, wherein said space of said second member is adapted for holding at least part of said first fastening part.

9. The support arm according to claim 1, wherein said second fastening part is hingedly connected to the other end of the second member, said second fastening part comprising:
an attachment part having a first side for attaching to a flatscreen, and a second side provided with
a first, horizontal axle, substantially parallel to a plane of movement of said arm, rotatably mounted to it,
a second, vertical axle, substantially parallel to the rotational axes of the hinges of said arm, fixed to the horizontal axle and rotatably mounted at the other end of the second member for providing a hinged connection of said second fastening part to said second member.

10. A support arm for a flat screen, like an LCD display, for mounting the flat screen to a surface, like a wall, comprising:
a first fastening part for attaching the support arm to said surface,
a first member, at one end hingedly connected to said first fastening part,
a second member, at one end hingedly connected to the other end of the first member,
a second fastening part for attaching the flat screen to the support arm, and which is hingedly connected to the other end of the second member, said second fastening part comprising:
an attachment part having a first side for providing an attachment to a flatscreen, and a second side provided with
a first, horizontal rod, substantially perpendicular to said hinges and rotatably mounted to said attachment part,
a second, vertical rod, fixed to the horizontal axle, tiltably mounted to the attachment part and rotatably mounted at the other end of the second member for providing a hinged connection of said second fastening part to said second member.

11. The support arm of claim 10, wherein said attachment part has slots, and said attachment part further comprises an attachment plate for attaching to a flatscreen and having hooks for engaging in said slots,

12. A fastening part for connecting a flat screen to an end of an arm for allowing said flatscreen to tilt and swivel with respect to said end of said arm, said fastening part comprising:
an attachment part having a first side for attaching to a flatscreen, and a second side provided with
a first, horizontal axle or pin, rotatably mounted to said attachment part,
a second, vertical axle or pin, fixed to the horizontal axle and rotatably mountable to the end of the arm for providing a hinge connection of said second fastening part to said second member.

13. The fastening part of claim 12, further having a blocking which engages said second axle for holding said attachment part in a tilt position.

14. The fastening part of claim 13, wherein said blocking comprises at least one slotted lip, and an end of said second axle extends through said slot.

15. A support arm, comprising one or more of the characterising features described in the description and/or shown in the attached drawings.
